(19) United States
(12) Patent Application Publication
(10) Pub. No.: US 2009/0018932 A1
(43) Pub. Date: Jan. 15, 2009

(54) System and method for idea sharing

(76) Inventors: Dave Evans, Southlake, TX (US); Mike Heronime, Dallas, TX (US); Susan Taylor, Dallas, TX (US)

Correspondence Address: RG & ASSOCIATES, 1103 TWIN CREEKS, STE. 120, ALLEN, TX, 75013, US

(21) Appl. No.: 12/217,878

(22) Filed: Jul. 9, 2008

Related U.S. Application Data
(60) Provisional application No. 60/948,518, filed on Jul. 9, 2007.

(51) Int. Cl. G06Q 30/00; G06F 17/30

(52) U.S. Cl. 705/27; 707/102; 707/3; 707/E17.005

(57) ABSTRACT

An idea sharing community, particularly for marketing and branding, includes a database and an interface. The interface allows idea providers to upload creative idea proposals to the database. Idea users can search for idea proposals and purchase the idea proposals. The idea sharing community may include a brand interaction system in which brands may be presented with online discussion boards etc that allow users to upload creative ideas in respect of the brand.

### CROSS REFERENCE TO RELATED APPLICATIONS

This application claims the benefit of U.S. Provisional Application No. 60/948,518 filed Jul. 9, 2007, the disclosure of which is incorporated herein by reference.

### FIELD OF THE INVENTION

The present application relates generally to service industry collaboration, and more particularly to incorporating community input to problems and facilitating contacts within a community to match needs with capability.

### BACKGROUND OF THE INVENTION

Crowdsourcing occurs when an entity (such as a corporation) outsources a task to an undefined set of task performers, such as a large group of people over the Internet. Crowdsourcing leverages talents of willing people and facilitates communication with agents who might otherwise not be available for a task, or who might not otherwise be known.

Crowdsourcing is a relatively new model and has not yet been widely embraced. For example, some companies may not be prepared to make the needed shifts in their businesses, as implementing within a corporation can have significant implications. Most companies do not have, or are not willing to dedicate, the resources necessary to properly take advantage of crowdsourcing in their particular area.

What is required is a system and method that facilitates the sharing of ideas within a community.

### SUMMARY OF THE INVENTION

In one embodiment of the disclosure, there is provided an idea community comprising at least one database and at least one interface. The database stores a plurality of idea user profiles and a plurality of idea provider profiles. The interface allows an idea user to upload an idea requirement to the database and allows an idea provider to search idea requirements in the database. The interface allows an idea provider to select an idea requirement and to upload an idea proposal to the database and to associate the idea proposal with a selected idea requirement.

In one embodiment of the disclosure, there is provided a method for sharing creative ideas comprising providing an interface, allowing a first user to upload an idea proposal to a database through the interface, and allowing a second user to search idea proposals in the database and select at least one idea proposal.

In one embodiment of the disclosure, there is provided a brand interaction system comprising an interface configured to present a brand category to a user, and allow the user to provide a brand idea.

### BRIEF DESCRIPTION OF THE DRAWINGS

The invention will now be described, by way of example only, with reference to specific embodiments and to the accompanying drawings in which :

FIG. 1 illustrates an idea community;

FIG. 2 illustrates a web site structure for an idea community;

FIG. 3 illustrates an introductory page of the website structure;

FIG. 4 illustrates a personalized page of the website structure;

FIGS. 5 to 8 illustrate web page forms for uploading a Request For Proposal;

FIG. 9 illustrates a web page for searching Request For Proposals;

FIG. 10 illustrates a web page for uploading an idea proposal;

FIG. 11 illustrates a web page for uploading idea proposals to a searchable database;

FIG. 12 illustrates a web page for searching the idea database and purchasing idea proposals;

FIG. 13 illustrates a brand interaction system; and

FIG. 14 illustrates a method for sharing ideas using the idea community.

### DETAILED DESCRIPTION OF THE INVENTION

The present disclosure includes, in one embodiment, a system and method to establish new modes of connection between communities, such as service providers and those desiring services. Embodiments of the present disclosure can be incorporated in various different industries where tasks, such as services, are sourced outside the company or entity desiring those services.

In one example embodiment, systems of the present disclosure are implemented in the context of advertising. In this example, the present innovations extend beyond the current advertising models to establish new modes of connection between a community and a marketer.

This embodiment may be practiced using a web or other network interface to create an open marketplace attended or populated by people with marketing needs, and those who provide needs to marketers. The innovations facilitate matching of marketers and creative talent that can satisfy their needs. In example embodiments, marketing needs are posted in community interface points, such as in a forum, blogs, or other Internet presences. Those who can provide services post bids to satisfy the marketing needs. Alternatively, the community posts ideas to solve the marketing needs, and marketers bid on the ideas. The bidding process can be originated by either side.

In other embodiments, a database is maintained with facts and trends which engage the community in generating ideas. This preferably results in a social network that can be used to promote dialogue, brands, ideas, and other community needs.

Though the embodiments to be described are applicable across various industries, an illustrative case is shown in the context of marketing. This example description is intended only to convey the ideas presented herein, and is not intended to limit the scope or applicability of the present innovations to any one industry or context.

In one example embodiment, a web or other network interface is used to create an open marketplace attended or populated by people with marketing needs, and those who provide needs to marketers. In one example, marketing needs and solutions are posted and matched or bid on so that needs and providers can find each other, communicate, and transact. Hence, the present embodiments create an open marketplace where marketing solutions are matched to problems. This can help facilitate a company's connection to creative talent. It also provides access for individuals to the marketplace and work without first engaging in permanent or standard employer-employee relationships.

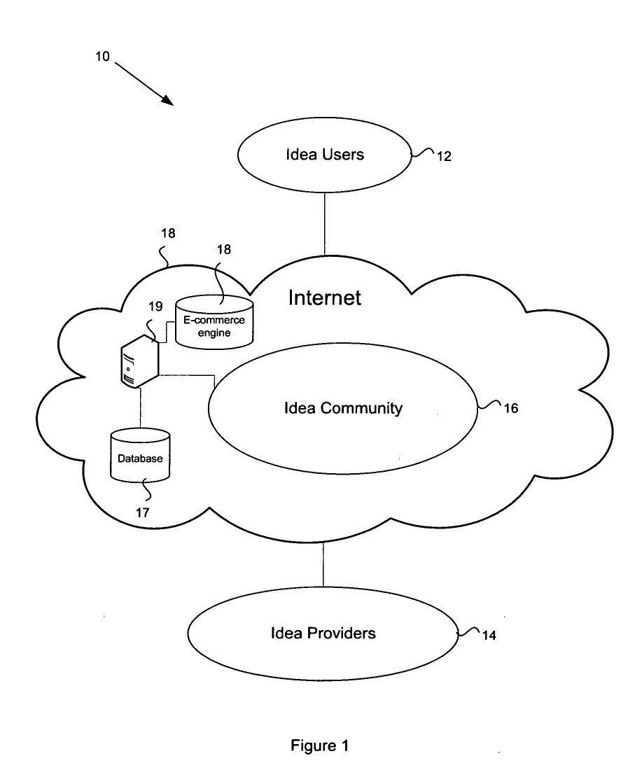

An example of an idea marketplace 10 is shown in FIG. 1. The idea marketplace 10 includes idea users 12 and idea providers 14 that communicate through an idea community 16 provided over the internet 18. In one embodiment, the idea users may be brand owners, advertisers and the like whereas the idea providers may be independent, such as the general public, or consortiums of like minded persons such as groups of advertising providers.

The idea community 16 may be presented as a web interface that includes a database 17 and a server 19 that provides data communication between the database 17 and the web interface. An electronic commerce engine 13 may also be provided.

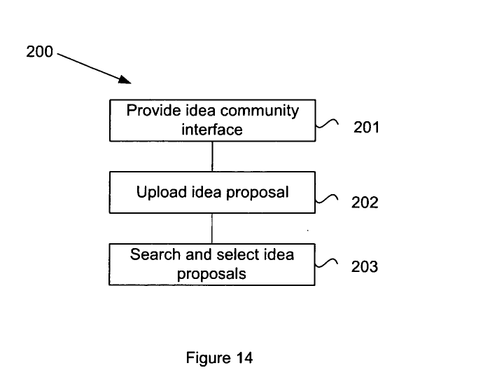

A method for using the idea community 16 to share creative ideas is illustrated in the flowchart 200 of FIG. 14. The method includes providing an interface (step 201). Using the interface, a first user may upload an idea proposal to the database (step 202). A second user may then search idea proposals in the database and select at least one idea proposal (step 203).

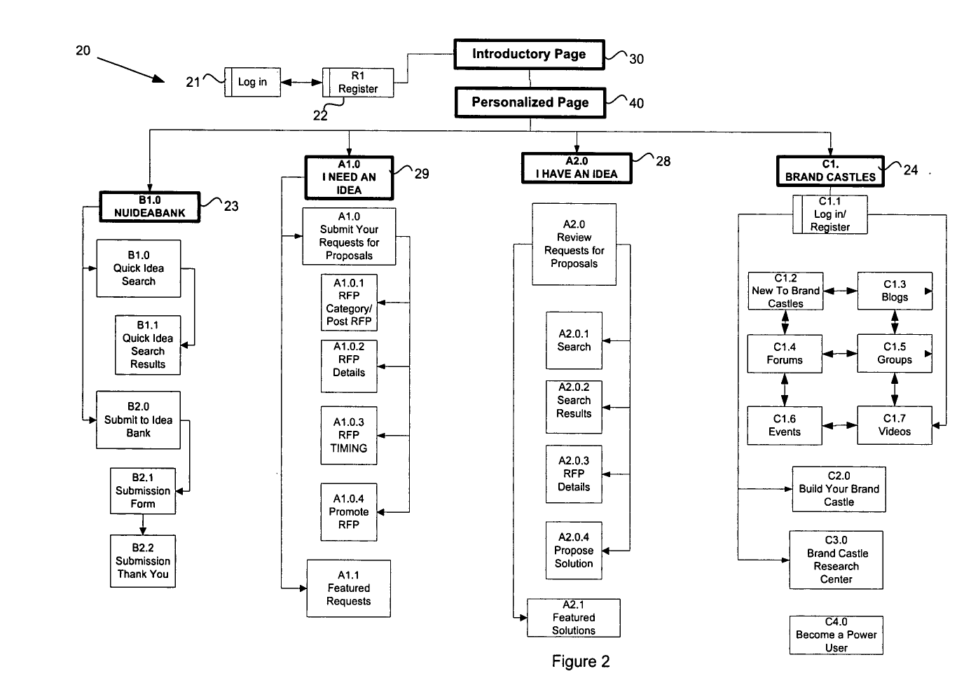

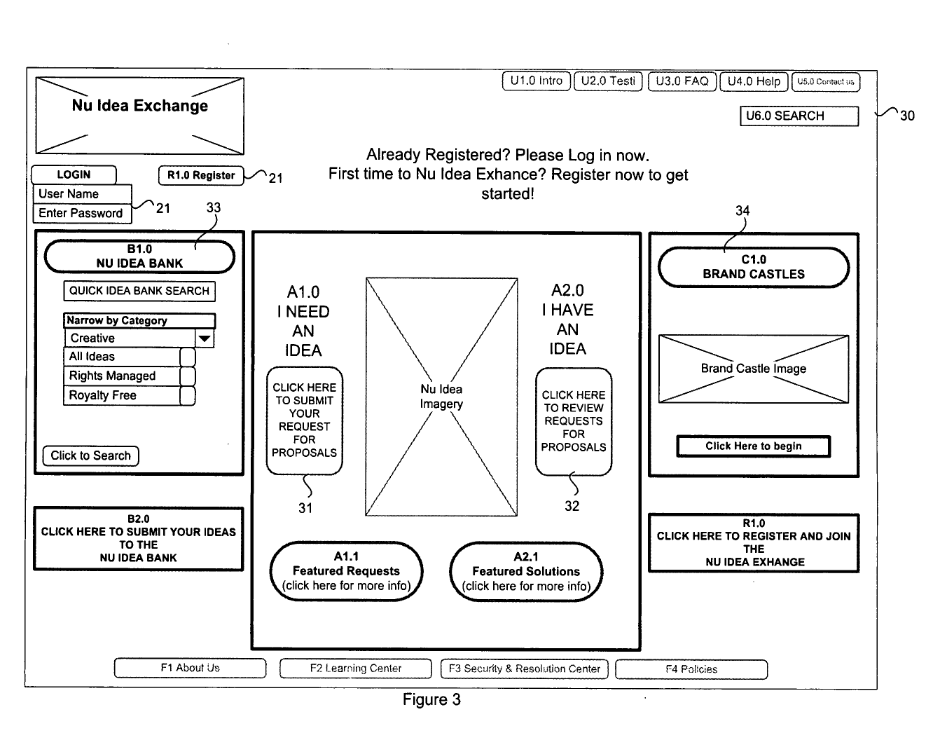

An example of a website structure 20 for the idea community is illustrated in FIG. 2 and includes an introductory webpage 30, shown in more detail in FIG. 3. With reference to FIGS. 2 and 3, the idea community may include a login 21 for existing users or a registration 22 for new users. Through the registration 22, a user may create a user profile, such as an idea user profile or an idea provider profile that may be stored in the database 17. In some embodiments, registration to the website may not be necessary for a user to access some portions of the website, whereas other portions of the website may be made available only to registered users. Both login and registration procedures are well known within the field of internet webpage construction and so no further details of the login or registration procedures will be described herein.

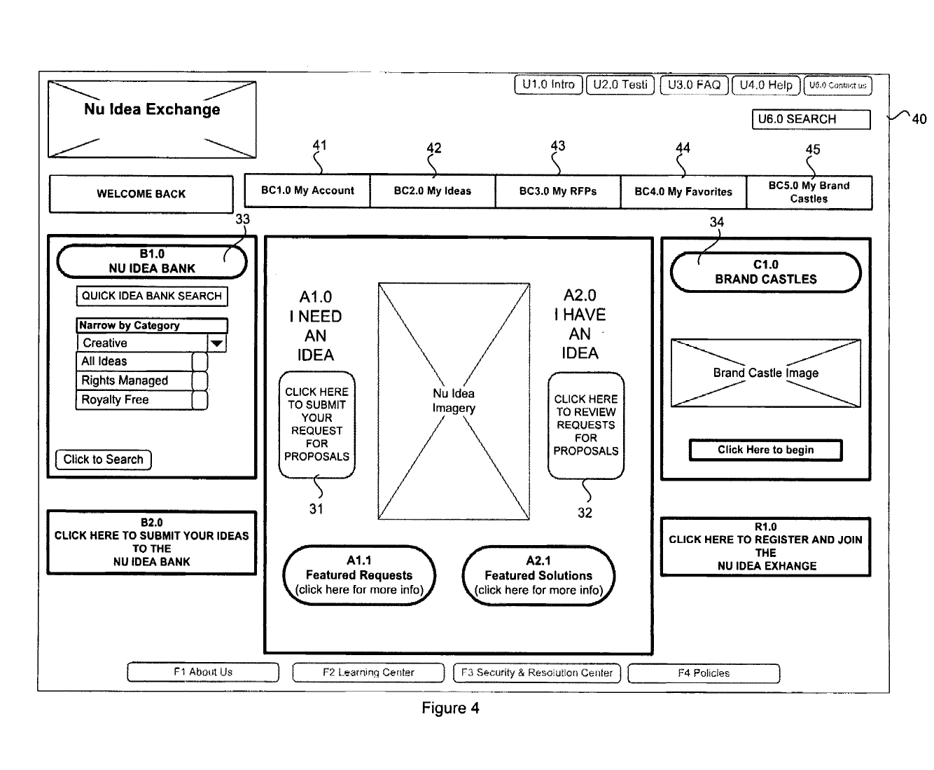

If the user logs in to the website, personalized settings for the user are retrieved from the database 17 by the server 19 and used to present a personalized webpage 40 to the user. An example of a personalized webpage 40 is illustrated in FIG. 4. The personalized webpage includes links to the user's account details 41, the user's submitted ideas 42, the user's Request For Proposals 43, favorites 44 and a brand interaction system 45. For an idea user, the favorites 44 may include an address book of favorite idea providers whereas for an idea provider, the favorites 44 may include an address book of favorite idea users. It will be understood that any particular user may be both an idea user and an idea provider, and thus the favorites may contain addresses of both favorite idea providers and favorite idea users.

The personalized web profile may also include the distinctive characteristics that support the user with unique promotional opportunities. Through this structure a user can build a profile of explicit uniqueness about themselves or their group and have the ability to promote these distinctive qualities to a mass audience or specific users. As a user provides personalized information they will be prompted with support tools to increase their effectiveness as a user of the site and will be presented with a user population to promote their resources.

Because registration and login may not be required, both the introductory webpage 30 and the personalized webpage 40 allow the user to navigate the website structure 20.

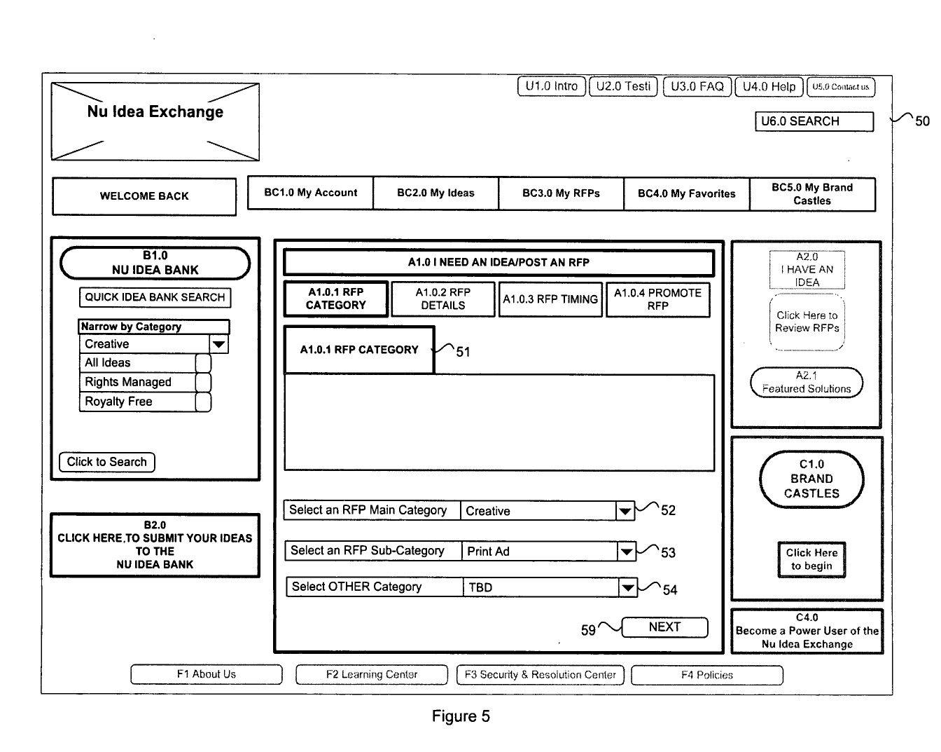

In one embodiment, the user may be an idea user seeking new and creative ideas for a project. By selecting the “I need an idea” icon 31, the idea user may post a request for proposal. The “I need an idea” icon 31 hyperlinks the user to the request for proposal structure 29 shown in FIG. 2 in which the idea user is presented with a series of webpage forms for submitting details of a Request For Proposal. A webpage 50 for uploading Request For Proposal details is depicted in FIG. 5. The Request For Proposal webpage 50 may include fields for entering a category 51. The category 51 may have a hierarchical structure such as a Main Category 52, Sub-Category 53 as well as Other category 54.

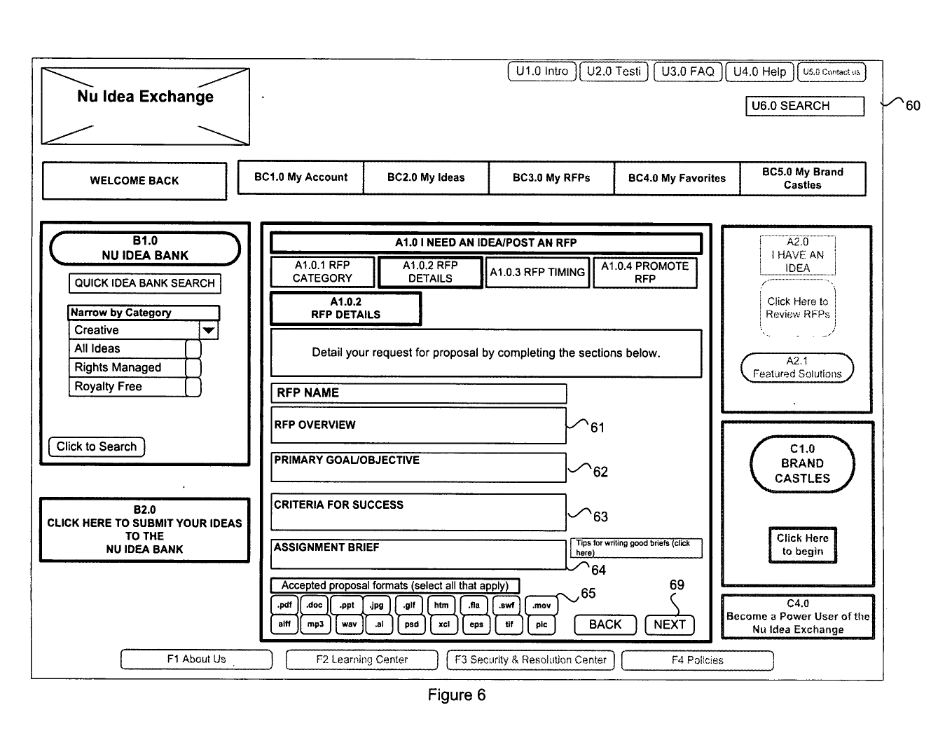

By selection of the “Next” button 59, the user is taken to a Request For Proposal details page 60, depicted in FIG. 6, which includes fields in which the user may enter details such as an overview 61, a primary goal or objective 62, criteria for success 63 and an assignment brief 64. Attachments may also be provided in a variety of formats by selection of the appropriate attachment icon 65.

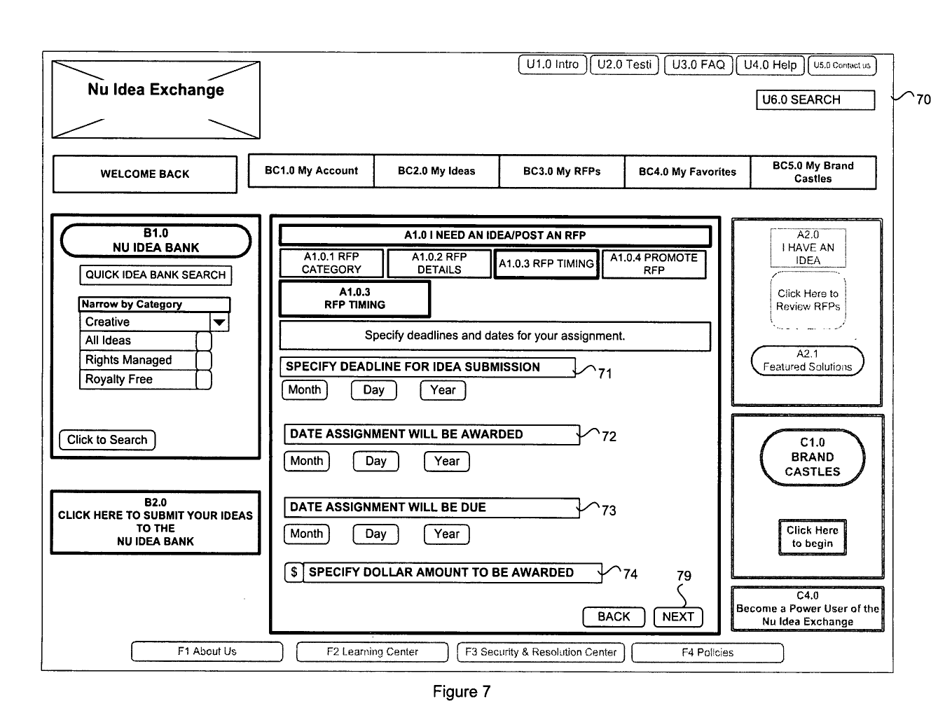

By selection of the “Next” button 69, the user is taken to a Request For Proposal timing page 70, depicted in FIG. 7, which includes fields in which the user may enter details such as a deadline for idea submission 71, a date the assignment may be awarded 72, a date by which the assignment is due 73 and a dollar amount that may be awarded 74.

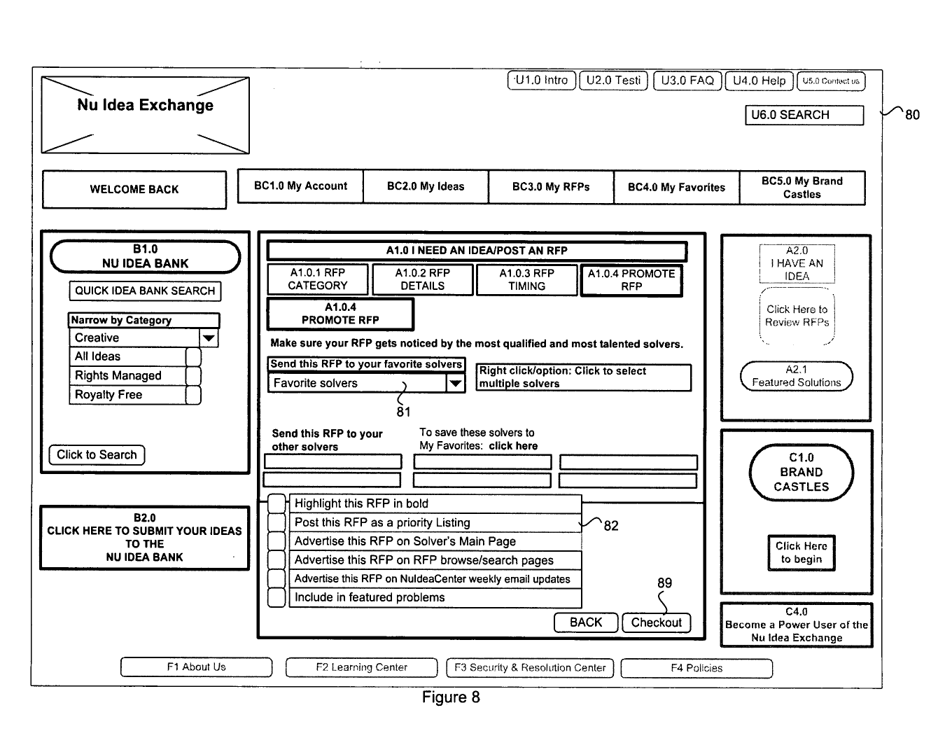

By selection of the “Next” button 79, the user is taken to a Request for Proposal promotion page 80, depicted in FIG. 8. The promotion page 80 allows the user to specify how a Request For Proposal may be advertised on the idea community 16. Different promotion methods may have different associated cost structures. The Request For Proposal may be promoted on the general idea community in a new Request For Proposals forum or advertised in a periodic, e.g. weekly, update. Promotion options 82 may be provided on the webpage 80. In one embodiment, the user is able to select or specify one or more favorite idea providers 81 and to promote the Request For Proposal directly to the selected idea providers. When the selected idea providers next log in to the idea community 16, the idea providers are notified of the new Request For Proposal. Alternatively or in addition, the selected idea providers may receive an email communication, text message or similar notifying the idea provider that they have a new Request For Proposal to consider.

By selection of the “Checkout” button 89, the Request For Proposal details are entered as a new Request For Proposal in the system database 17 and the Request For Proposal is promoted in accordance with the methods selected by the user.

While a series of webpage forms for entering a Request For Proposal is illustrated and described, the person skilled in the art will understand that all details may by provided on a single webpage form or a greater or lesser number of webpage forms than have been described.

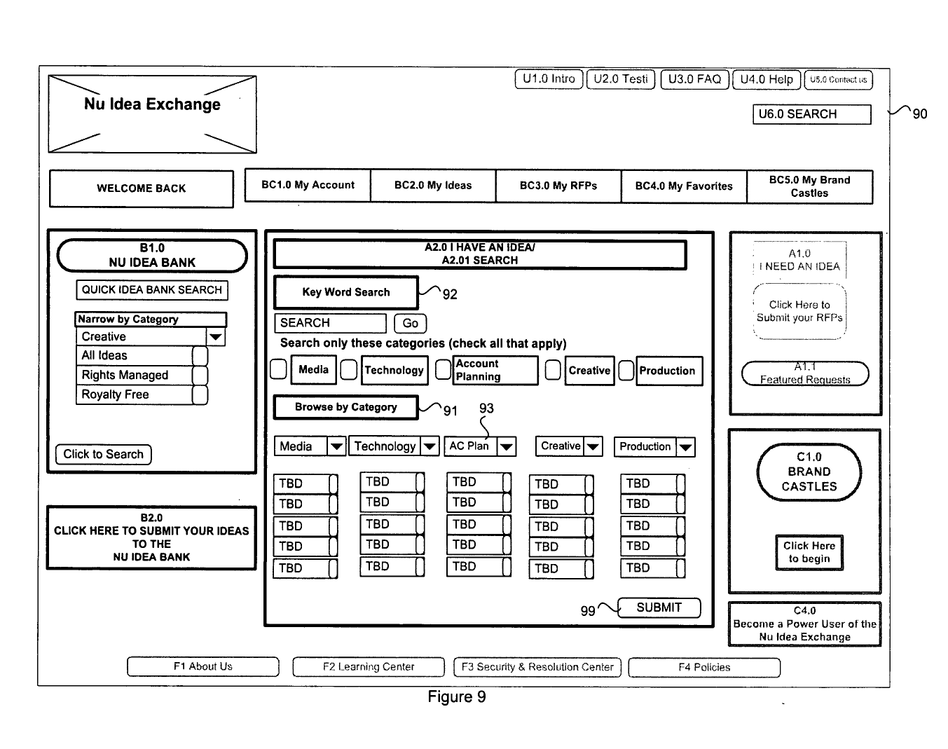

In one embodiment, the user may be an idea provider with new and creative ideas to promote. By selecting the “I have an idea” icon 32 on the introductory page 30 (FIG. 3) or their personalized page 40 (FIG. 4), the idea provider is hyperlinked to a search interface structure 28 (FIG. 2) for searching Request For Proposals that may match the idea providers' idea. A search interface 90 is depicted in FIG. 9. The search interface 90 may allow a user to browse 91 Request For Proposals or to search on keywords entered in keyword field 92. The user may also narrow both browsing and searching by specifying one or more categories, subcategories etc 93. Though not shown, the user may also enter additional search criteria such as deadline, cost etc.

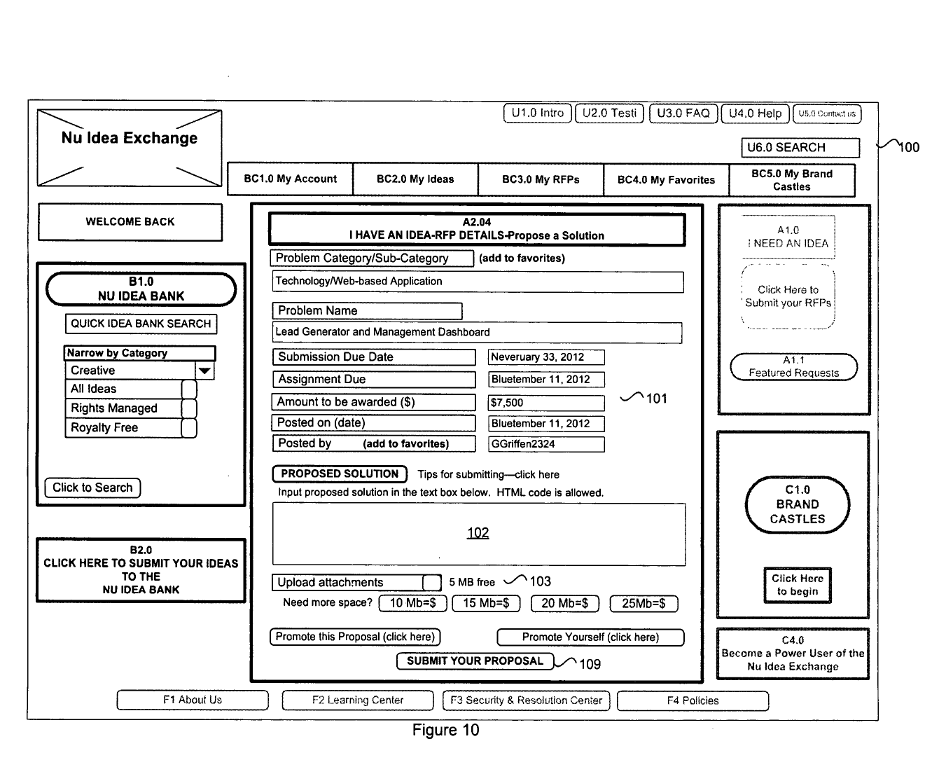

When the user selects the submit icon 99, the search is performed on all relevant database records and the user is presented with a series of Request For Proposals that match the search criteria. From a search results page, an idea provider may request more details of the Request For Proposal and/or propose an idea. A webpage 100 for proposing a solution is depicted in FIG. 10. The solution webpage 100 shows all the details 101 of the Request For Proposal in distinct fields. The webpage 100 also includes fields 102 allowing the idea provider to enter text details of a solution or idea that matches the Request For Proposal requirements. In addition, the idea provider is able to upload attachments 103 that contain further aspects of the idea provider's proposal. By selecting the Submit Proposal icon 109, the proposal is stored in the database 17 of the idea community 16 and a link created between the owner account and the proposal that authorizes the owner to access the proposal details. The owner of the Request For Proposal may be notified of the proposed solution. For example, a suitable notification may be provided when the owner next logs in to the idea community 16. Alternatively or in addition, the owner may receive a direct notification, e.g. by email or text message from the idea community.

In one embodiment, the “amount to be awarded” field may be omitted or hidden from the idea provider in the search results. Hiding the amount to be awarded can encourage an idea provider to provide the most competitively priced proposal.

In one embodiment, proposed solutions may be viewable only by the owner of the Request For Proposal. In an alternative embodiment, a proposed solution may be posted on a new proposals forum, enabling multiple users to view the proposed solution. Contact details provided in the forum may allow an interested person to contact the idea provider.

The idea community 16 may also include an idea bank, which may be a catalogue of submitted ideas stored in the system database 17. Access to the idea bank may be through an icon 33 on the introductory page 30 (FIG. 3) or the personalized page 40 (FIG. 4). When the idea bank icon 33 is selected, the user is hyperlinked to an idea bank 23 (FIG. 2).

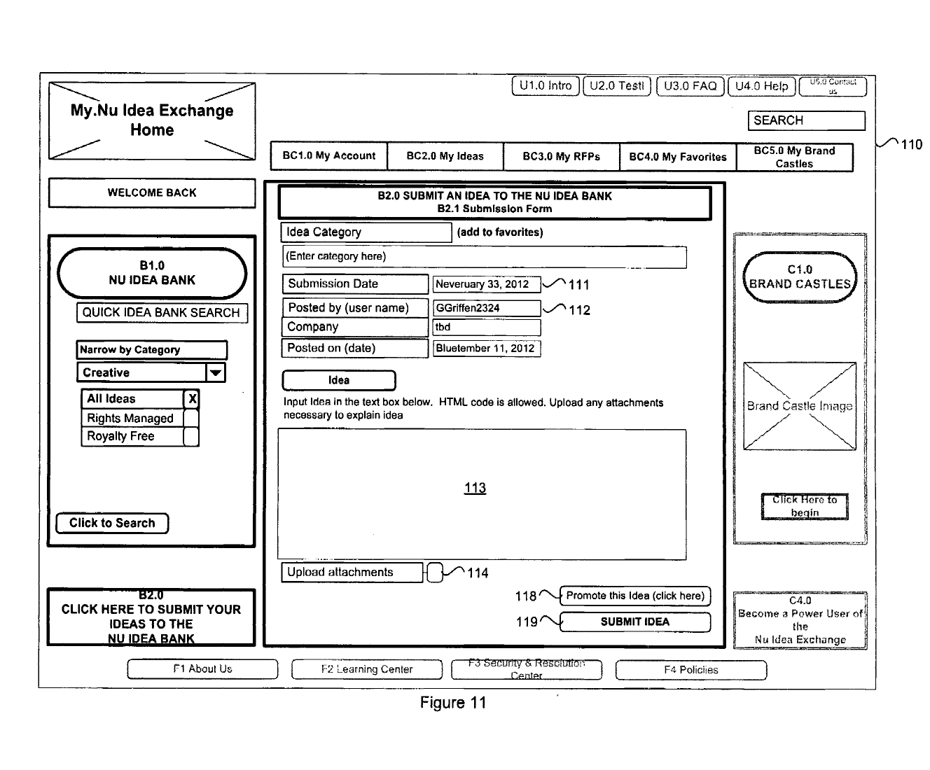

The idea bank interface may allow the user to upload an idea to the idea bank 23. A webpage 110 providing an upload interface is depicted in FIG. 11. The webpage 110 is similar to the webpage 100 illustrated in FIG. 10 and includes fields for allowing a user to nominate a submission date 111, the identity of the idea provider 112, and idea details 113. The idea provider may also upload attachments 114 that further detail the idea. Upon selection of a submission button 119, the idea is uploaded to the idea bank 23. An icon 118 to directly promote the idea to potential suitors may also be provided. Though not shown, the idea provider may also specify how an idea may be purchased. For example, an idea may be rights managed, such as by assignment, or an idea may be purchased on a royalty fee basis such as by a license. Standard assignment or licensing agreements may be uploaded with the idea into the idea bank, thus enabling a potential purchaser of the idea to fully appraise the commercial worth of an idea.

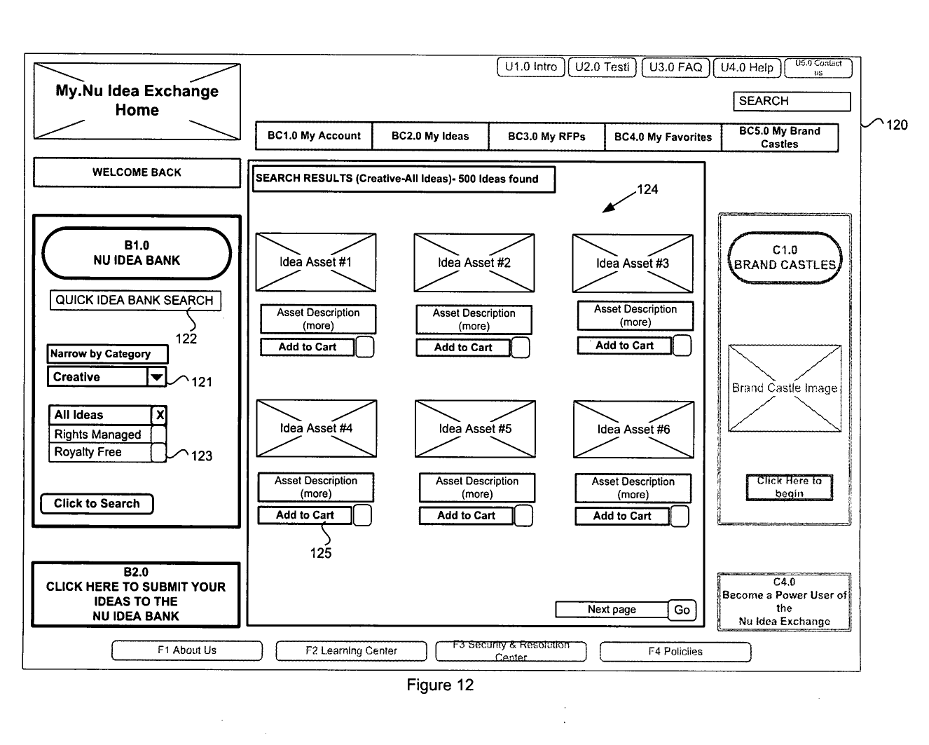

Using the idea bank, a user, such as an idea user, may search on all catalogued ideas, or those available ideas that have been uploaded but are not associated with any Request For Proposal. A search interface 120 is illustrated in FIG. 12. The search interface 120 may allow a user to search on category fields 121, keywords 122 as well as whether an idea is rights managed or available on a royalty basis 123. More detailed searches may be performed by the addition of more search fields. The search interface 120 may present all ideas matching the search criteria in a list 124.

The selection of some ideas may be too expansive for the user to manage. An administration system module may be provided that will be activated to control all components of a selected idea. This schema provides the user with active controls to establish database parameters defined when selecting the idea. This module engages the user through a process flow and produces reporting characteristics to manage the function.

The idea community 16 may be provided with an e-commerce engine 13 (FIG. 1) including a shopping cart that allows a user to purchase individual ideas and proposals through standard web-based selection and payment processes. Each idea or proposal in the list 124 may be presented with an “Add to Cart” icon 125 that adds the selected idea to a user's shopping cart.

Ideas in the idea bank may be single purchase ideas in which case, the idea is removed from the idea bank after purchase. Alternatively, ideas in the idea bank may allow multiple purchases, in which case the idea record may linger in the database until some expiry deadline is reached, or a maximum number of purchases of the idea have been made.

In one embodiment, a bidding system may be provided in which ideas in the idea bank are provided with an expiration time. Idea users may bid for the rights to the idea by registering a bid. At the expiration time, the highest bid is awarded the rights to the idea registered in the idea bank. Online bidding systems are generally known in internet technology and thus no further details of the online bidding system are provided herein.

The idea community 16 includes a brand interaction system 24 (FIG. 2) indicated by the name Brand Castles, which is a trademark of the present assignees. The brand interaction system 24 may be accessed through a brand interaction icon 34 on the introductory page 30 (FIG. 3) or the personalized page 40 (FIG. 4). The brand interaction system allows a brand owner to create a self contained brand community for a particular brand.

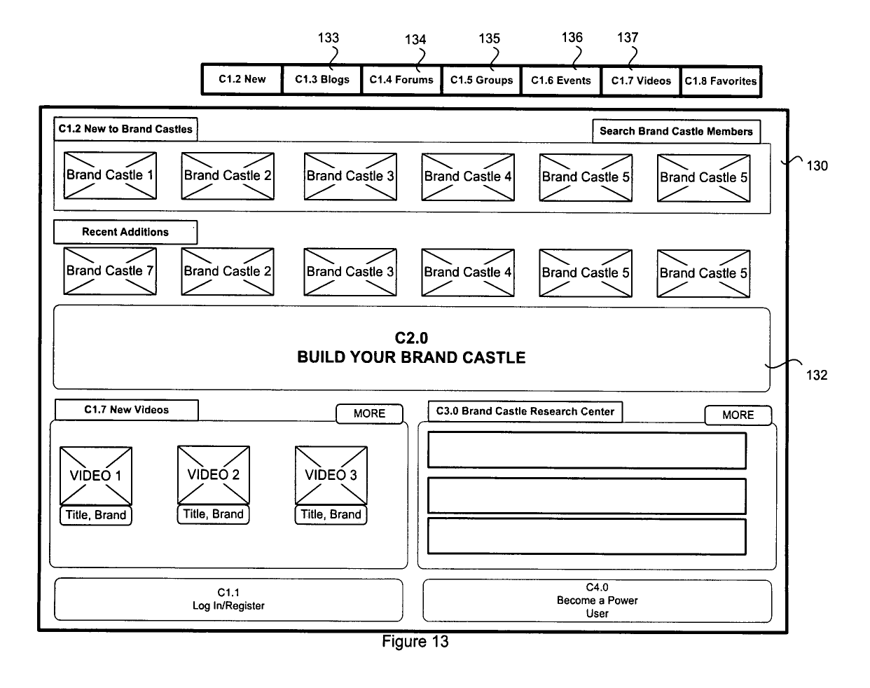

The brand interaction may require an additional log in. Once a brand owner has accessed the brand interaction system 24, the brand owner may be presented with a brand interaction interface 130 shown in FIG. 13. The brand interaction interface 130 shows all of the brand communities that the brand owner is a member of, which may include the brand owners own brands, as well as brands of others.

The brand interaction interface 130 allows a brand owner to build a brand community centered around a particular brand by selecting a “Build” icon 132. To create a new brand community, the brand owner may upload a logo or trademark depicting the brand as well as additional information such as a product description. For each brand community, there is provided community interface points including blogs 133, forums 134, discussion groups 135, events 136 and videos 137. The brand owner may also upload videos featuring promotions, advertisements, endorsements and presentations related to the brand, such as a video demonstration or presentation of a product associated with the brand

A user that accesses the brand interaction system may join any brand community and participate through the community interface points. Through these community interface points, a user may view new ideas and market directions for the brand, proposed videos, advertisements etc that have been uploaded by the brand owner to the brand community. The user may then participate in discussions and offer suggestions or creative ideas regarding the market directions of a brand as well as conceive ideas that may be uploaded as creative ideas to the idea bank described previously and/or directly to the brand community. Ideas provided by the user may be provided to the brand owner directly, rather than through a public discussion group, thus enabling the idea provider to be appropriately compensated.

In one embodiment, a first user may upload an idea that can take on the characteristics of a strategic concept. The second user may then select this as a strategic idea as it may be defined in broad terms. The upload of this idea and the selection could present the impact of changing a brands characteristic when produced. The selection of this strategic idea will be supported through documentation established in the database that defines the unique characteristics of the strategy.

In one embodiment, innovation modules support users with components that extend the creative process through the interaction of database driven queries. The queries prompt creative development with engaging subject matter relating to the foundation of an idea and innovative technologies. A user engages with a module to upload an idea and the module creates intuitive prompts to cause the user to broaden the idea with innovative features.

In one embodiment, a research feature may be provided. The research feature is updated daily with consumer activity and provides consumer behavior trends that present content to the user community who can activate the creative process with these insights of a consumer in specific industry categories. These behavior nuggets allow the user to extend ideas that are prompted by uploaded projects. These ideas can also be uploaded to the idea bank for future selection.

The embodiments described herein facilitate matching of marketers and creative talent that can satisfy their needs. In example embodiments, marketing needs are posted, such as in a forum, blogs, or other Internet presences. Those who can provide services post bids to satisfy the marketing needs. Alternatively, the community posts ideas to solve the marketing needs, and marketers bid on the ideas. The bidding process can be originated by either side.

In other embodiments, a database is maintained with facts and trends which engage the community in generating ideas. This preferably results in a social network that can be used to promote dialogue, brands, ideas, and other community needs. The database can be accessed by members of the community, such as marketers, to troll for ideas that can match their needs. Alternately, the database can be mined by those providing services seeking jobs that their services can satisfy. This can happen in a broad sense, such as vague descriptions of jobs or needs for manpower or specific skill sets, or it can happen in more narrow ways, such as by listing specific needs or guidelines for a task, including information needed to complete the task or otherwise transact between a marketer and creative thinkers.

It is noted that these steps can vary within the scope of the present innovations. For example, initial contact can be made by either marketers or providers. Bids can be uploaded by providers, or alternatively, by marketers who see solutions they like. Communication can be masked (so that only anonymous bids can be submitted, or only anonymous tasks can be posted) or they can be open, with disclosure of personal or other information. Various kinds of information can be submitted.

As will be recognized by those skilled in the art, the embodiments described in the present application can be modified and varied over a tremendous range of applications, and accordingly the scope of patented subject matter is not limited by any of the specific exemplary teachings given.

For example, though the present innovations are described with respect to the advertising or marketing context, the concepts disclosed herein can be implemented in a wide range of contexts, including other businesses, other communities, and even other ways of creating contacts between these entities. The Internet is the preferred embodiment for network used to facilitate contact and embody the innovations.

For example, website searches can be performed, for example, by class or need, or by bids, or by other pricing criteria, such as how certain rights to an idea or service are offered (e.g., rights-managed or royalty free). Other users may deposit ideas, services, solutions, or other subject matter into the community, and these deposits can be searchable. In preferred embodiments, the community is roughly divided between those in need of services and those providing services, though this distinction is not mandatory.

Needs and offerings to the community can be entered based on a classification scheme. For example, deposits could be classified by subject matter, or applicability within a certain industry, price, rights offered, time frames, formats, criteria, etc. Sub-categories can be added to create a multi-tier searchable database.

In preferred embodiments, those searching for subject matter within the community, or those depositing subject matter, go through a step-by-step process that guides them through the searching or submission process, presenting various options to be selected, or permitting users to define their own options, tags, criteria, etc.

In other embodiments, searches are performed, for example, by keyword, while in other embodiments categories can be browsed, based on one or more of various organization schemes. For example, in one embodiment, relating to advertising, categories include media, account planning, creative, production, and technology. Each category preferably sub-categories at varying levels.

In some embodiments, deposits into the community can be tagged or defined, such as with metadata or by other means, so that searches can be refined. Tags and subcategories can be pre-defined, or can be generated and searched by key word, for example.

In other embodiments, users are guided through question-and-answer sections that help navigation through the community, or help depositing in or searching the community.

Search results can preferably be searched in various ways, such as by sorting or classifying the results.

The present innovations also include various controls for how users can contact one another, for example, users may submit personal information, or may choose to remain anonymous for some part of the process. Contacts can be managed directly, or through the web site (or another interface).

In one embodiment, the user account allows the user to store a set of known favorite idea providers. When a user creates an idea requirement, the user may post the idea requirement directly to the idea providers. This exploits the existing direct relationship between the user and the idea provider and has the advantage of ensuring that the idea provider is directly made aware of the user's idea requirement, rather than relying on the idea provider searching system.

Embodiments of the invention, such as the idea community 16 can operate on or via any electronic device that has a processor and memory. The production and presentation of the web pages may be performed by a processor retrieving information, images, templates etc from an operatively associated memory. In addition, information provided by the user and provided to the user may be stored in a memory and provided by the processor which is operably coupled to the memory.

Although embodiments of the present invention have been illustrated in the accompanied drawings and described in the foregoing description, it will be understood that the invention is not limited to the embodiments disclosed, but is capable of numerous rearrangements, modifications, and substitutions without departing from the spirit of the invention as set forth and defined by the following claims. For example, the capabilities of the invention can be performed fully and/or partially by one or more of the blocks, modules, processors or memories. Also, these capabilities may be performed in the current manner or in a distributed manner and on, or via, any device able to provide and/or receive information. Further, although depicted in a particular manner, various modules or blocks may be repositioned without departing from the scope of the current invention. Still further, although depicted in a particular manner, a greater or lesser number of modules and connections can be utilized with the present invention in order to accomplish the present invention, to provide additional known features to the present invention, and/or to make the present invention more efficient. Also, the information sent between various modules can be sent between the modules via at least one of a data network, the Internet, an Internet Protocol network, a wireless source, and a wired source and via plurality of protocols.

What is claimed is:

1. An idea community comprising:
at least one database; and
at least one interface;
wherein the database stores a plurality of idea user profiles;
wherein the database stores a plurality of idea provider profiles;
wherein the interface allows an idea user to upload an idea requirement to the database;
wherein the interface allows an idea provider to search idea requirements in the database;
wherein the interface allows an idea provider to select an idea requirement; and
wherein the interface allows the idea provider to upload an idea proposal to the database and to associate the idea proposal with a selected idea requirement.

2. The idea community according to claim 1 wherein the interface allows an idea provider to promote an idea proposal directly to an idea user.

3. The idea community according to claim 1 further comprising an electronic commerce engine that allows an idea user to purchase an idea proposal.

4. The idea community according to claim 3 wherein the interface allows a second idea user to purchase the idea proposal using the electronic commerce engine.

5. The idea community according to claim 1 wherein the interface provides a bidding interface that allows a plurality of idea users to place a bid for an idea proposal.

6. A method for sharing creative ideas comprising:
providing an interface;
allowing a first user to upload an idea proposal to a database through the interface; and
allowing a second user to search idea proposals in the database and select at least one idea proposal.

7. The method according to claim 6 further comprising allowing the first user to specify an idea category for the idea proposal.

8. The method according to claim 6 wherein selecting at least one idea proposal comprises purchasing an idea proposal.

9. The method according to claim 8 wherein an idea proposal indicates a number of allowed purchases of the idea proposal.

10. The method according to claim 9 further comprising preventing further purchases of an idea proposal after an allowed number of purchases of the idea proposal have occurred.

11. The method according to claim 6 further comprising allowing the second user to place a bid for an idea proposal.

12. The method according to claim 11 further comprising awarding an idea proposal to a user that places a highest bid.

13. The method according to claim 6 wherein an idea proposal indicates rights associated with the proposal.

14. The method according to claim 13 wherein the idea proposal indicates how the rights associated with the proposal may be acquired.

15. The method according to claim 14 wherein a purchase of an idea proposal comprises an assignment of the rights associated with the proposal.

16. The method according to claim 14 wherein a purchase of an idea proposal comprises a purchase of a license of the rights associated with the proposal.

17. The method according to claim 6 further comprising allowing the first user to provide the idea proposal directly to an account of a second user.

18. A brand interaction system comprising an interface configured to:
present a brand category to a user; and
allow the user to provide a brand idea.

19. The brand interaction system according to claim 18 wherein the interface further comprises at least one online community interface point associated with the brand category.

20. The brand interaction system according to claim 18 further comprising means for presenting a plurality of brands, allowing a user to select a brand, and allowing the user to upload an idea in respect of the selected brand.
